(19) United States
(12) Patent Application Publication
(10) Pub. No.: US 2013/0298896 A1
(43) Pub. Date: Nov. 14, 2013

(54) COMBINATIONAL PORTABLE COOKING DEVICE

(71) Applicant: Keith Norman Johnson, Conway, SC (US)

(72) Inventor: Keith Norman Johnson, Conway, SC (US)

(21) Appl. No.: 13/890,094

(22) Filed: May 8, 2013

Related U.S. Application Data
(60) Provisional application No. 61/644,048, filed on May 8, 2012.

(51) Int. Cl. A47J 37/07

(52) U.S. Cl. CPC A47J 37/0713
USPC 126/25 R

(57) ABSTRACT

The invention provides a portable cooking device which comprises a containment space having, and typically enclosing, a propane tank. The device also has a cooking tier arrangement which comprises one or more cooking tiers. The cooking tiers have cooking tier covers and cooking surfaces. The cooking surfaces may be a combination of one or more means for cooking The device also has a cooking tier control panel comprising one or more cooking surface controls and a structural frame.

### CROSS-REFERENCE TO RELATED APPLICATIONS

This application is a non-provisional application of U.S. application Ser. No. 61/644,048, filed May 8, 2012, entitled: COMBINATIONAL PORTABLE COOKING DEVICE, the contents of which are hereby incorporated by reference.

### FIELD

In general, embodiments disclosed herein relate to a combinational portable cooking device system.

### BACKGROUND

Outdoor grilling and cooking is an activity that most families enjoy partaking in. Even more so, people enjoy the convenience of a grill during camping trips. Traditionally, cooking devices such as gas grills and the like are large and equally immobile. During an instance where the grill needs to be moved to different locations, such as a camping trip or tailgating event, transporting a grill can become a fairly cumbersome task. Additionally, when transporting both a grill as well as a propane tank, a person would need additional resources as one person cannot carry the load of both a grill and a propane tank in one trip.

Furthermore, the typical grill only comprises one type of cooking surface. Thus if an individual wanted to both grill and cook traditional items on a stove, they would need to bring both a grill and a portable burner. Additionally, personal storage in a car or truck bed may be limited, thus transporting multiple cooking devices may be difficult. Likewise, owning multiple cooking devices can be cost prohibitive and inconvenient. As such, solutions are needed that allow a cooking device to be easily portable and have multiple cooking surfaces.

### SUMMARY

The following presents a simplified summary of several embodiments of the invention relating to a portable cooking device. For example, in one embodiment of the present invention, a portable cooking device is provided that comprises a containment space, a cooking tier arrangement, a cooking tier control panel, and a structural frame.

The cooking tier arrangement has one or more cooking tiers. The one or more cooking tiers each have a respective cooking surface. The cooking surfaces serve to be a means for cooking In one embodiment the cooking surface may be a grill. In another embodiment, the cooking surface may be a burner. In one embodiment, the containment space may include a propane tank connected to at least one cooking surface. The cooking surfaces are controlled by the cooking tier control panel. In one embodiment, the cooking tier control panel may have controls to adjust the temperature of a respective cooking surface. In another embodiment, the cooking tier control panel may have a spark igniter.

The structural frame offers stability and a means for expanding or stacking the portable cooking device. The structural frame comprises a handle, cooking tier support arms, a first and second pair of telescoping legs, a wheel axle, and a pair of wheel, where the wheel rotates about the wheel axle. In one embodiment, the cooking tiers may be expanded such that the cooking tiers are parallel to one another. In another embodiment, the cooking tiers may be stacked such that the cooking tiers are directly aligned with one another in the vertical direction.

According to embodiments of the invention, a portable cooking device comprises a structural frame; and a cooking tier arrangement comprising a first cooking tier comprising a first cooking surface and a first heating component, the first cooking tier connected to the structural frame; and a second cooking tier comprising a second cooking surface and a second heating component, the second cooking tier connected to the structural frame; wherein the first cooking tier or the second cooking tier is adjustable with respect to the structural frame such that the cooking tiers may be re-arranged from a cooking configuration to a stack configuration wherein one of the cooking tiers is positioned substantially above the cooking surface of the other cooking tier.

In some embodiments, the first cooking surface and the second cooking surface are substantially parallel when in the cooking configuration. In some embodiments, the first cooking tier defines a containment space configured to hold a fuel tank functionally connected with the first heating component or the second heating component by a propane regulator and for fueling the functionally connected heating component.

In some embodiments, the first cooking tier or the second cooking tier comprises a cooking tier cover for covering the cooking surface when the heating component is not in use. In some such embodiments, the cooking tier cover is configured to extend from the cooking surface of the cooking tier when not covering the heating component for use as a table. In other such embodiments, the cooking tier cover is detachable and re-attachable for covering the other cooking surface.

In some embodiments, the first cooking tier or the second cooking tier comprises a cooking tier hood for providing a grilling hood when the heating component is in use. In some embodiments, the portable cooking device also includes a cooking tier control panel comprising at least one heating component controls for controlling the first or second heating components. In some embodiments, the structural frame comprises a first and second cooking tier support arms connected to the first or second cooking tier; and a first and second pair of telescoping legs attached to the first and second cooking tier support arms, respectively. In some embodiments, the structural frame comprises a wheel axel; a pair of wheels attached to the wheel axel and for rotating about the wheel axel; and a handle configured for assisting a user to move the portable cooking device by holding the handle and rolling the wheels.

According to embodiments of the invention, a portable cooking device includes a structural frame; and a cooking tier arrangement having a central cooking tier comprising a central cooking surface and a central heating component, the central cooking tier connected to the structural frame; a first exterior cooking tier comprising a first exterior cooking surface and a first exterior heating component, the first exterior cooking tier connected to the structural frame; and a second exterior cooking tier comprising a second exterior cooking surface and a second exterior heating component, the second exterior cooking tier connected to the structural frame; wherein the first exterior cooking tier and the second exterior cooking tiers are adjustable with respect to the structural frame such that the cooking tiers may be arranged in a stack configuration whereby the first exterior cooking tier and the second exterior cooking tier are positioned substantially above the central cooking surface of the central cooking tier.

In some embodiments, when in the stack configuration, the second exterior cooking tier is positioned substantially above the first exterior cooking surface of the first exterior cooking tier.

According to embodiments of the invention, a portable cooking device includes a structural frame comprising a first pair of telescoping legs configured to extend to the ground for stabilizing the portable cooking device; and a cooking tier arrangement including a first cooking tier comprising a first cooking surface and a first heating component, the first cooking tier connected to the structural frame; and a second cooking tier comprising a second cooking surface and a second heating component, the second cooking tier connected to the structural frame; wherein the first cooking tier or the second cooking tier is adjustable with respect to the structural frame such that the cooking tiers may be arranged in a stack configuration whereby one of the cooking tiers is positioned substantially above the cooking surface of the other cooking tier.

In some embodiments, the structural frame further comprises a second pair of telescoping legs configured to extend to the ground for further stabilizing the portable cooking device. In some embodiments, the first pair of legs and the second pair of legs are functionally connected to the first cooking tier and are disposed on opposite sides of the first cooking tier. In some embodiments, the cooking tier arrangement further includes a third cooking tier comprising a third cooking surface and a third heating component, the third cooking tier connected to the structural frame; and wherein the first cooking tier is a central cooking tier and the second and third cooking tiers are exterior cooking tiers. In some such embodiments, the first cooking tier defines a containment space configured to hold a fuel tank functionally connected with the first heating component or the second heating component by a propane regulator and for fueling the functionally connected heating component. In other such embodiments, the first cooking tier or the second cooking tier comprises a cooking tier cover for covering the cooking surface when the heating component is not in use. In some of these embodiments, the cooking tier cover is configured to extend from the cooking surface of the cooking tier when not covering the heating component for use as a table

In some embodiments, the structural frame includes a wheel axel; a pair of wheels attached to the wheel axel and for rotating about the wheel axel; and a handle configured for assisting a user to move the portable cooking device by holding the handle and rolling the wheels.

### BRIEF DESCRIPTION OF THE DRAWINGS

Having this described embodiments of the invention in general terms; reference will now be made to the accompanying drawings, which are not necessarily drawn to scale.

FIG. 1 is a perspective view of a portable cooking device, in an expanded embodiment, according to the present invention;

FIG. 2 is an elevated view of the rear side of the portable cooking device of FIG. 1;

FIG. 3A is a plain view of the front side of the portable cooking device of FIG. 1;

FIG. 3B is a plain view of the front side of the portable cooking device of FIG. 1, with specific dimensions according to an embodiment of the present invention;

FIG. 4A is a plain view of the top side of the portable cooking device of FIG. 1;

FIG. 4B is a plain view of the top side of the portable cooking device of FIG. 5, with specific dimensions according to an embodiment of the present invention;

FIG. 4C is a plain view of the top side of the portable cooking device of FIG. 1, with specific dimensions according to an embodiment of the present invention;

FIG. 5 is a perspective view of a portable cooking device, in a collapsed embodiment, according to the present invention;

FIG. 6A is a plain view of the front side of the portable cooking device of FIG. 5;

FIG. 6B is a plain view of the front side of the portable cooking device of FIG. 5, with specific dimensions according to an embodiment of the present invention;

FIG. 7A is a plain view of the rear side of the portable cooking device of FIG. 5;

FIG. 7B is a plain view of the rear side of the portable cooking device of FIG. 5, with specific dimensions according to an embodiment of the present invention;

FIG. 8A is a plain view of the left side of the portable cooking device of FIG. 5;

FIG. 8B is a plain view of the left side of the portable cooking device of FIG. 5, with specific dimensions according to an embodiment of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “a” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

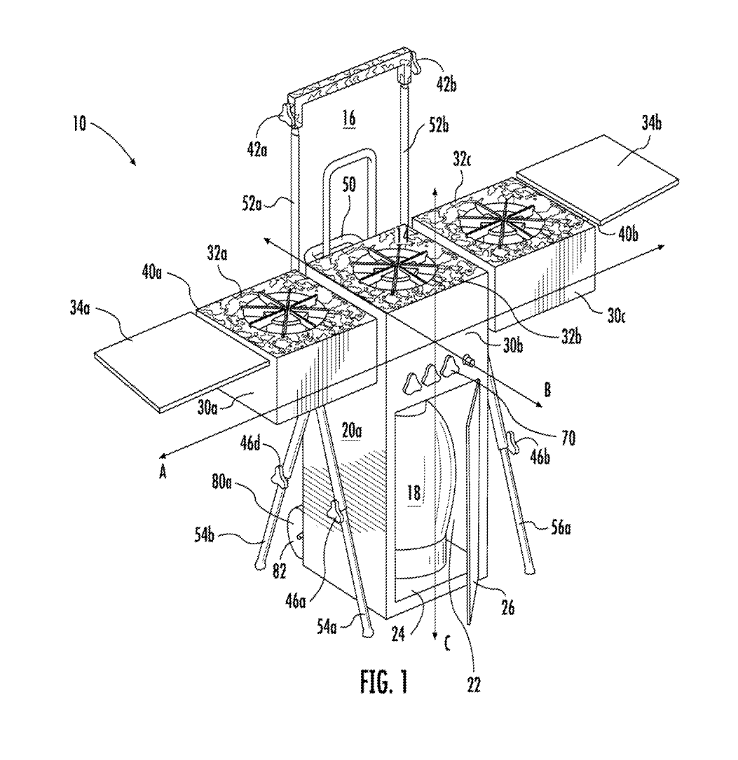

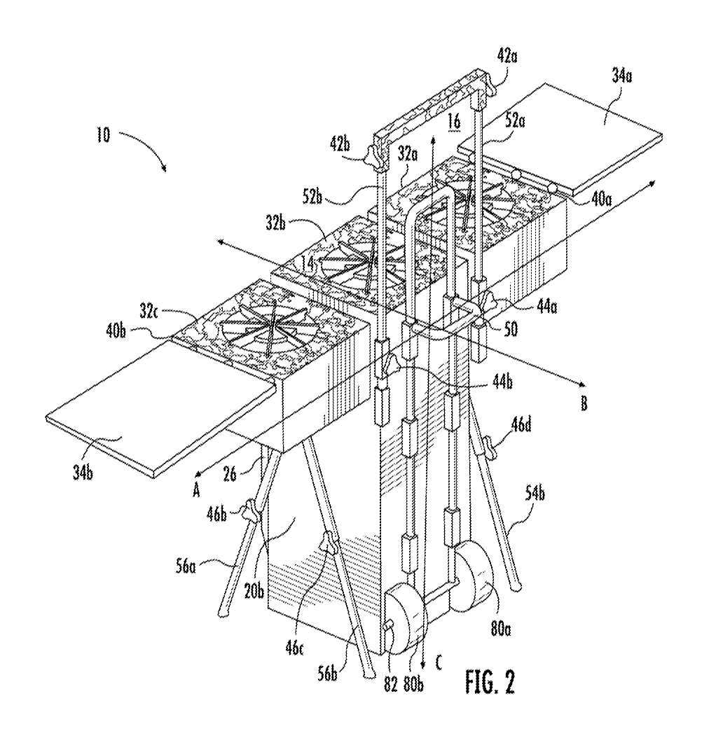

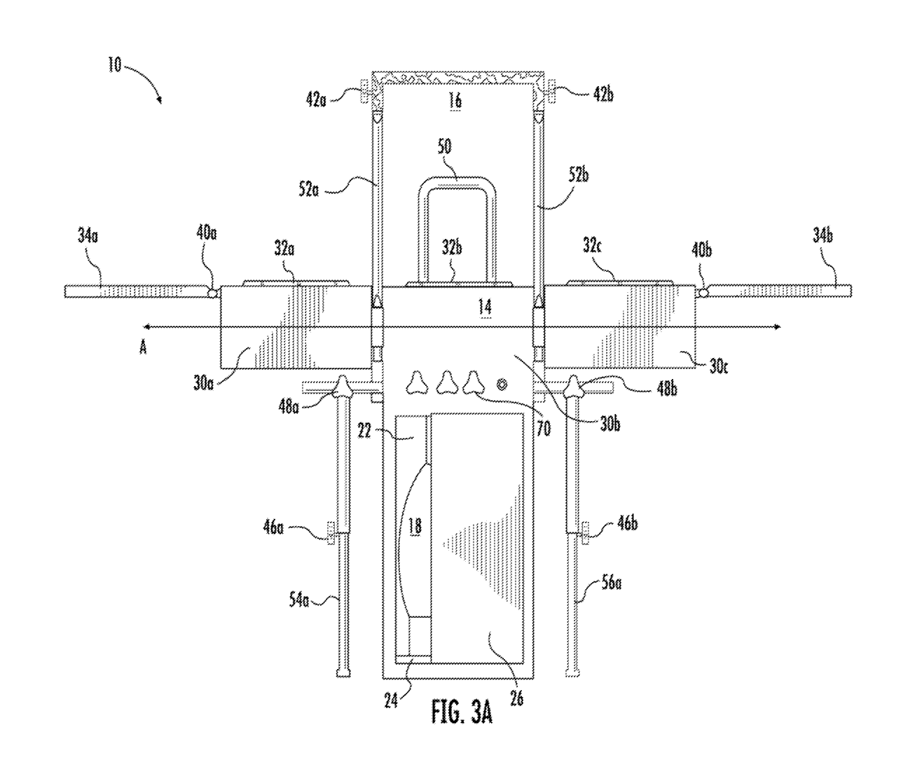

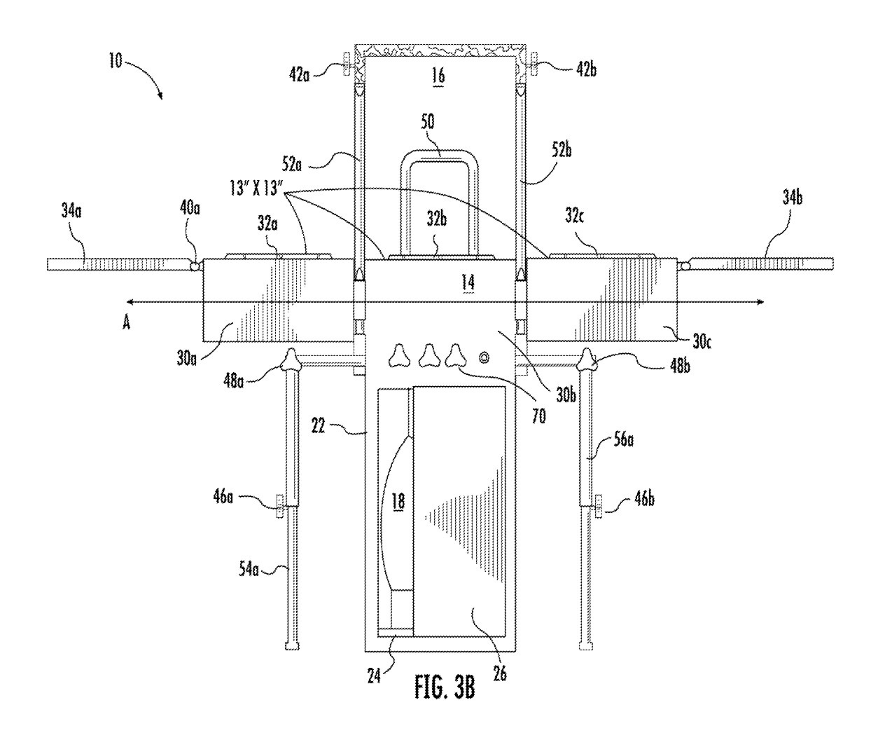

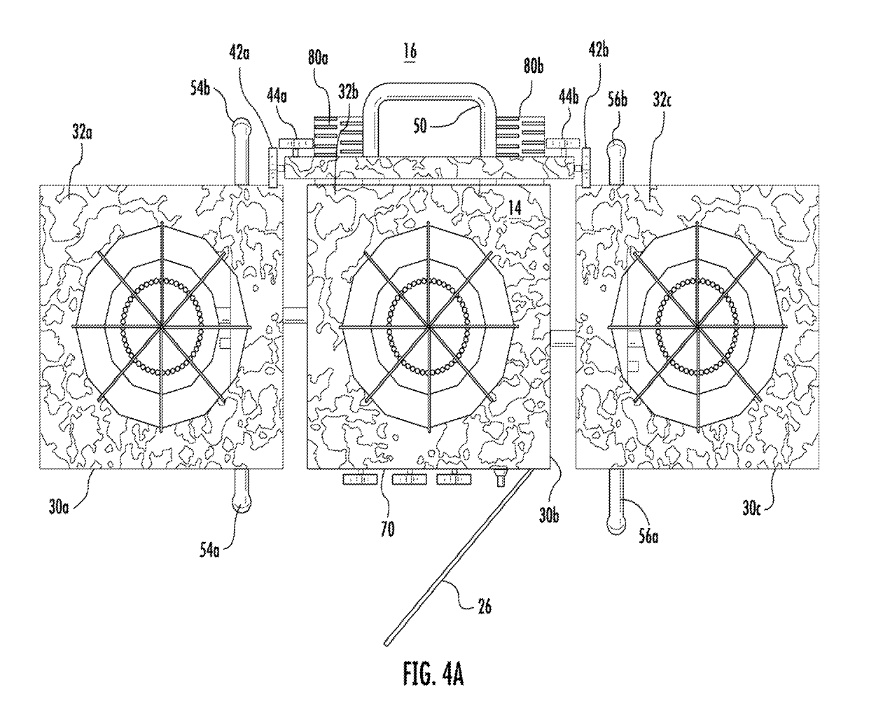

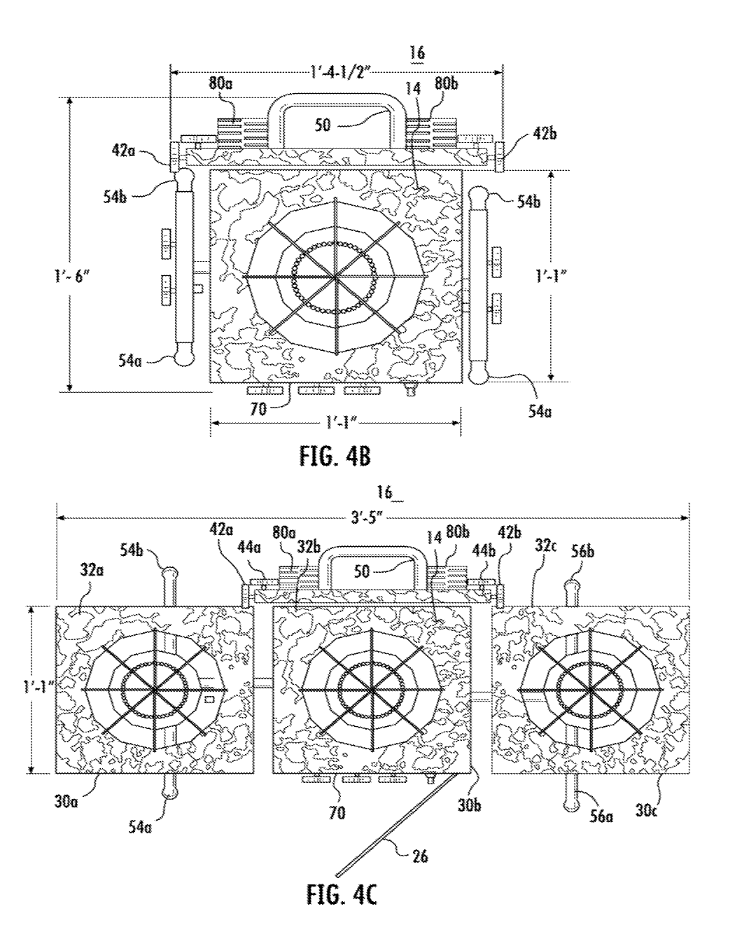

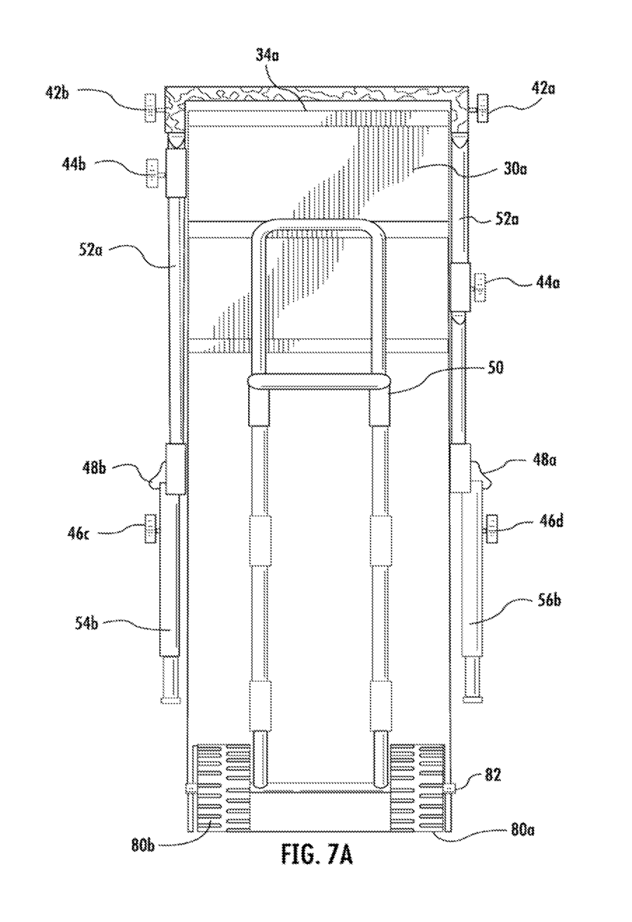

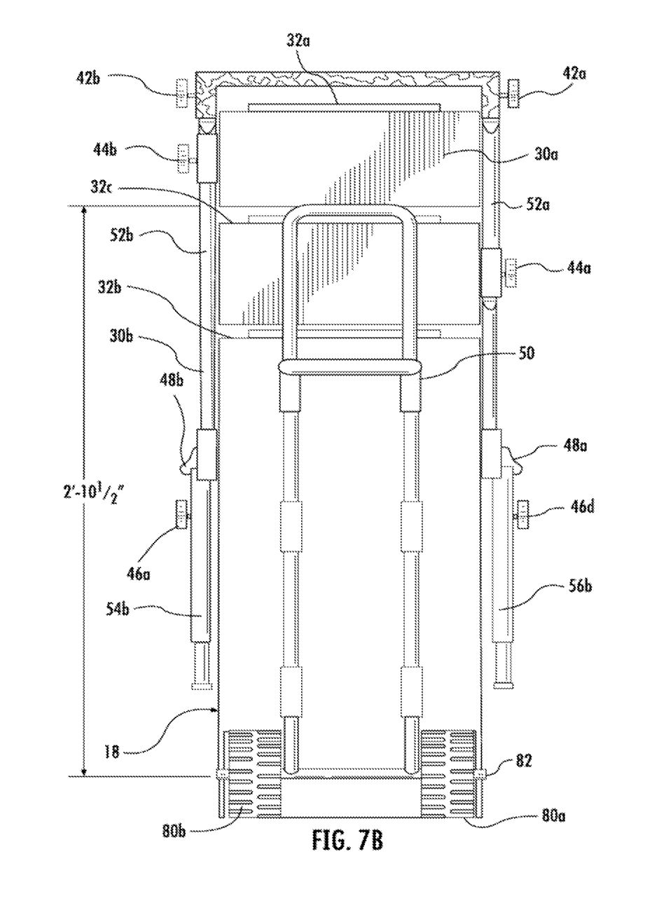

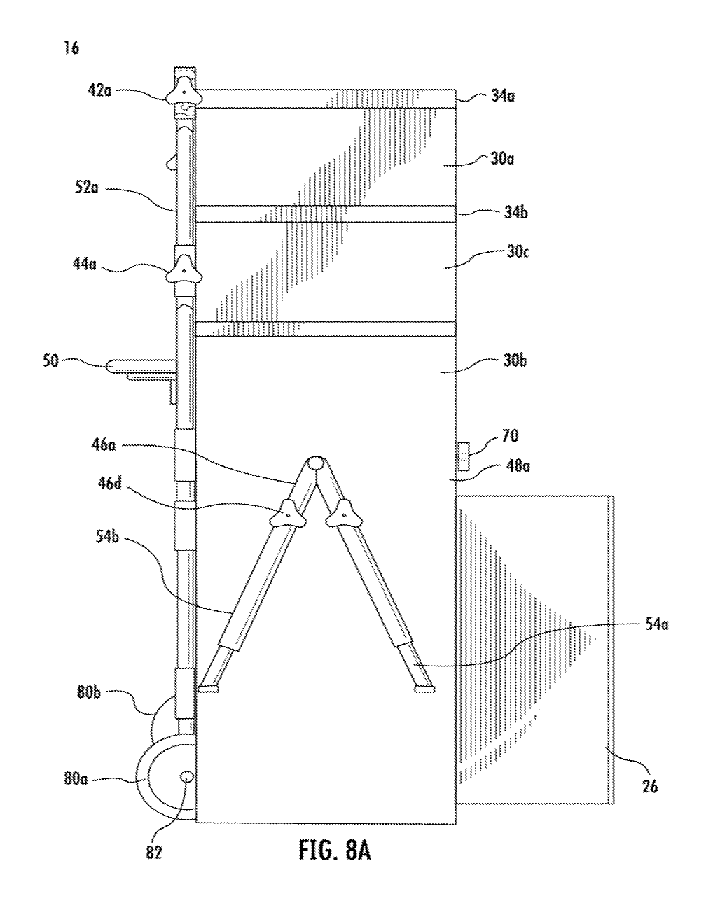

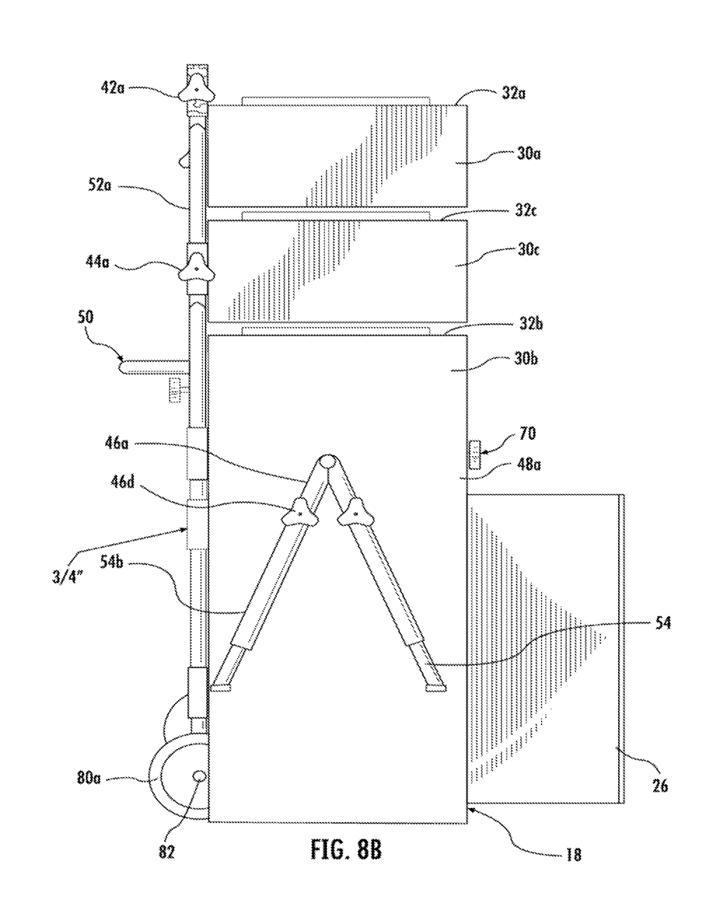

With reference to FIGS. 1-8, a portable cooking device 10 according to an embodiment of the present invention is illustrated. The portable cooking device 10 includes a body 14 and a structural frame 16. The body defines a containment space 18, a cooking tier arrangement 30, and a cooking tier control panel 70. The structural frame 16 defines a handle 50, cooking tier support arms 52a, 52b, a first pair of telescoping legs 54a, 54b, a second pair of telescoping legs 56a, 56b, a pair of wheels 80a, 80b, and a wheel axle 82.

As illustrated, the containment space 18 may be defined by containment walls 20a, 20b, 20c, an opening 22, a closed end 24, and an optional containment space door 26. The containment walls 20a, 20b, 20c may be defined by a first side edge, a second side edge, a top edge, and a bottom edge. The closed end 24 may be defined by a four side edges. The optional containment space door 26 may be defined by a first edge, a second edge, a top edge, and a bottom edge. In one embodiment, containment walls 20a, 20b extend along a first axis A of the portable cooking device 10. As such, containment walls 20a, 20b are parallel to one another. Containment wall 20c may extend along a second axis B of the portable cooking device 10. Containment wall 20c may be parallel to the opening 22. Containment walls 20a, 20c may intersect at their first and second side edges, respectively. Containment walls 20b, 20c may intersect at their second and first side edges, respectively. Opposed containment walls 20a, 20b, 20c may intersect with the closed end 24 at their bottom edges, thereby forming a hollow rectangular containment space 18.

In an alternative embodiment, the containment space 18 may be defined by a curved containment wall, an opening 22, a closed end 24, and an optional containment space door 26. The curved containment wall may be defined by a first side edge, a second side edge, a curved top edge, and a curved bottom edge. The closed end 24 may be defined a circular shape having a central point, a radius, and a curved edge defined by plurality of points equally distanced from the central point, for a length equivalent the radius, and extending about a third axis C. The optional containment space door 26 may be defined by a first side edge, a second side edge, a curved top edge, and a curved bottom edge. In one embodiment, the curved containment wall may intersect with the curved edge of closed end 24 at its curved bottom edge, thereby forming a hollow cylindrical containment space 18. In another embodiment, the containment space 18 may be squared. In yet another embodiment, the containment space 18 may be polygon shaped, including but not limited to a pentagon, hexagon, octagon and the like.

The optional containment space door 26 may intersect with the containment walls 20a, 20b or cooking tier control panel 70 such that it is appended to either a containment wall 20a, 20b or the cooking tier control panel 70. Means for appending the optional containment space door 26 may include, but not be limited to, hinges, springs, zippers, sliding mechanisms and the like. In one embodiment, the optional containment space door 26 and containment wall 20b intersect at their second and first side edges, respectively. For example, the optional containment space door 26 may be appended to containment wall 20b such that it opens, in the positive direction, and pivots about a third axis C for a range of motions from 0° to 180°. In another embodiment, the optional containment space door 26 and containment wall 20a intersect at their first and second side edges, respectively. For example, the optional containment space door 26 may be appended to containment wall 20a such that it opens, in the negative direction, and pivots about a third axis C for a range of motions from 0° to 180°. In another embodiment, the optional containment space door 26 and closed end 24 intersect at their bottom and side edge, respectively. For example, the optional containment space door 26 may be appended to closed end 24 such that it opens, in the negative direction, and pivots about a first axis A for a range of motions from 0° to 90°. In yet another embodiment, the optional containment space door 26 and the cooking tier control panel 70 may intersect at their top and bottom edges, respectively. For example, the optional containment space door 26 may be appended to cooking tier control panel 70 such that it opens, in the positive direction, and pivots about a first axis A for a range of motions from 0° to 180°.

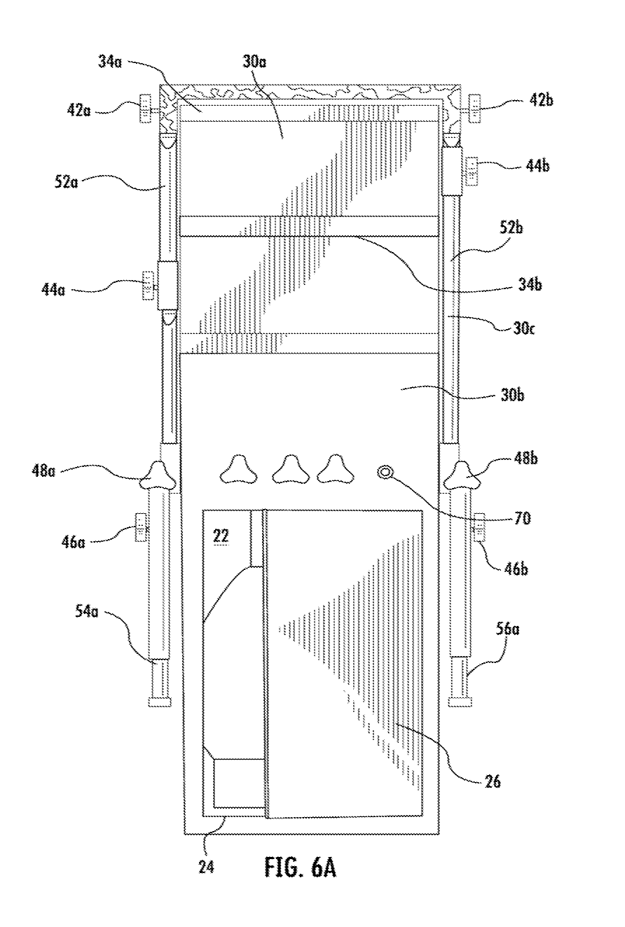

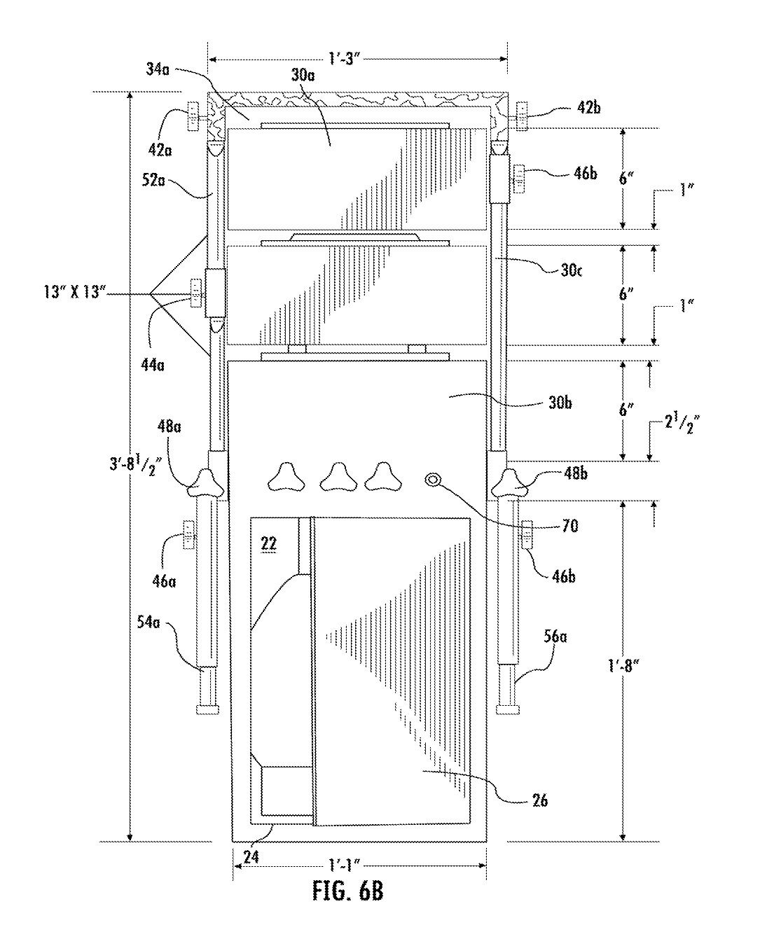

In one embodiment, the containment space may be used as a propane compartment, such that the optional containment space door 26 may enclose a propane tank in the containment space. In another embodiment, the containment space may be used as additional storage. As such, the containment space may contain one or more drawers to accommodate items including, but not limited to, food, cooking utensils, charcoal, cooking grates, a water jug, and the like. Additionally, the one or more storage drawers may be removed if necessary to accommodate larger items. In another embodiment, the containment space 18 may contain a means for refrigeration. A means for refrigeration may include, but not be limited to, a cooler, a miniature deep freezer, a dry ice compartment, a miniature refrigerator, and the like. It should be noted that the containment space 18 may accommodate any combination of a propane tank, additional storage space, and a means for refrigeration. In one embodiment the optional containment space door 26 may comprise a means for securing the enclosed containment space 18. A means for securing the containment space may include, but not be limited to, a padlock, a combinational lock, a deadbolt and the like. In one embodiment, as illustrated in FIG. 6B, the dimensions of the containment space 18 may be 1′-8″×1′-1″×1′-1″ in length, width, and height respectively. A containment space of this size may accommodate a plurality of propane tank sizes or alternative items.

The cooking tier arrangement 30 is defined by one or more cooking tiers. As illustrated, in one embodiment, the cooking tier arrangement 30 may be defined by two exterior cooking tiers 30a, 30c and a central cooking tier 30b. In one embodiment, the cooking tiers 30a, 30b, 30c may be rectangular shaped. In another embodiment, the cooking tiers 30a, 30b, 30c may be squared. In another embodiment, the cooking tiers 30a, 30b, 30c may be cylindrical. In yet another embodiment, the cooking tiers 30a, 30b, 30c may be polygon shaped, including but not limited to a pentagon, hexagon, octagon and the like. The cooking tier arrangement 30 may be organized in a variety of positions. As illustrated in FIG. 1, the cooking tiers 30a, 30b, 30c may be expanded, such that the cooking tiers 30a, 30b, 30c extend across a first axis A, in a parallel manner. Additionally, the exterior cooking tiers 30a, 30c may be non-stationary. As such, the exterior cooking tiers 30a, 30c may be vertically adjusted along a third axis C. In one embodiment, the exterior cooking tiers 30a, 30c may be vertically adjusted along the support arms 54a, 54b, such that the exterior cooking tiers 30a, 30c may be elevated to any height that does not exceed the height of support arms 54a, 54b, but may not be lowered below the height of the containment space 18. In one embodiment, the exterior cooking tiers 30a, 30c are individually adjustable and may be positioned at different heights. In another embodiment, the exterior cooking tiers 30a, 30c may be connected such that the exterior cooking tiers 30a, 30c are jointly adjusted and automatically positioned at the same height. Furthermore, in one embodiment, the central cooking tier 30b may be stationary and non-adjustable. The central cooking tier 30b may intersect with the top edge of the cooking tier control panel 70 at their bottom and top edges, respectively. In an alternative embodiment, the cooking tier 30b may be non-stationary. Thus, the central cooking tier, at its lowest position, may rest upon the top edge of the cooking tier control panel 70, and may be elevated to any height that does not exceed the height of support arms 54a, 54b. In such an embodiment, the structural frame 16 may comprise a third support arm for the central cooking tier 30b. Non-stationary cooking tiers are advantageous as the cooking tiers 30a, 30b; 30c may be lowered below standard cooking level to accommodate taller cookware and the like. Likewise, the cooking tiers 30a, 30b, 30c may be elevated to a traditional height. In one embodiment, the cooking tiers 30a, 30b, 30c may be horizontally adjusted, in the positive direction, along a second axis B. As such, the cooking tiers may be positioned in front of the containment space 18, when adjusted. In one embodiment, the exterior cooking tiers 30a, 30, 30c are individually adjustable and may be arranged in different positions. In another embodiment, the exterior cooking tiers 30a, 30b, 30c may be connected such that the cooking tiers 30a, 30b, 30c are jointly adjusted and automatically arranged at the same position. In another embodiment, one or more cooking tiers may be individually adjustable and one or more cooking tiers may be jointly adjustable. For example, in one embodiment, exterior cooking tiers 30a, 30c may be extended along a second axis B, in the positive direction, while central cooking tier 30c remains stationary. In one embodiment, as illustrated in FIG. 6B, the dimensions of the cooking tiers 30a, 30b, 30c may be 13″×13″×16″ in length, width, and height respectively.

As illustrated in FIG. 1, the exterior cooking tiers 30a, 30c may comprise cooking tier covers 34a, 34b respectively. In one embodiment the cooking tier covers 30a, 30c are appended to the cooking tiers at their one of their outer edges. Means for appending the cooking tiers 30a, 30c may include, but not be limited to, hinges, springs, zippers, sliding mechanisms and the like. As illustrated, in one embodiment, the cooking tier cover 34a may be appended to cooking tier 30a using one or more hinges 40a. The cooking tier 34a may pivot about a second axis B and extend outwardly from the cooking tier 30a, 180° in the negative direction of axis A, such that when in resting position the cooking tier cover 34a may serve as a table and/or ledge. Likewise, the cooking tier cover 34b may be appended to cooking tier 30c using one or more hinges 40b. The cooking tier cover 34b may pivot about a second axis B and extend outwardly from the cooking tier 30c, 180° in the positive direction, such that when in resting position the cooking tier 34b may serve as a table and/or ledge. In another embodiment, the cooking tier covers 34a, 34b may pivot about a first axis A and extend outwardly from the cooking tiers 30a, 30c respectively, 180° in the positive direction of axis B, such that when in resting position the cooking tier covers are positioned in front of the containment space 18. In another embodiment, the cooking tier covers 34a, 34b may pivot about a first axis A and extend outwardly from the cooking tiers 30a, 30c respectively, 180° in the negative direction of axis B, such that when in resting position the cooking tier covers are positioned behind the containment space 18. In another embodiment the cooking tier covers 34a, 34b may be shaped as a grill hood, such that a cooking tiers 30a, 30c having a grill shaped cooking tier cover 34a,34b may be arranged in the first position of the cooking tier arrangement 30 stack, to accommodate the height and shape of the hood shaped cooking tier cover. In one embodiment, the hood shaped cooking tier covers 34a, 34b may be appended to cooking tiers 30a, 30c using one or more hinges 40a, 40b respectively. The grill shaped cooking tier covers 34a, 34b may pivot about a first axis A and extend upward from the cooking tiers 30a, 30c respectively, 90° in the negative direction along a second axis B, such that when in resting position the hood shaped cooking tier covers 34a, 34b may serve as a grilling hood. In another embodiment, the cooking tier covers 34a, 34b may pivot about a first axis A and extend outwardly from the cooking tiers 30a, 30b respectively, 90° in the positive direction of axis B, such that when in resting position the hood shaped cooking tier covers are positioned in front of the containment space 18. In another embodiment, the hood shaped cooking tier covers 34a, 34b may pivot about a second axis B and extend outwardly from the cooking tiers 30a, 30c respectively, 90°, such that when in resting position the cooking tier covers 34a, 34b may serve as a grilling hood positioned on the sides of the portable cooking device 10. In yet another embodiment the hood shaped cooking tier covers 34a, 34b may be removable such that it can be reattached to any cooking tier 30a, 30b, 30c. For example, cooking tier 30c may have a hood shaped cooking tier cover, and may be arranged in the first position of the cooking tier arrangement 30 stack, while cooking tiers 30a, 30c may have table shaped cooking tier covers 34a, 34b respectively, and may be arranged in either the second or third position of the cooking tier arrangement 30 stack. In one embodiment, cooking tier 30b may have a removable cooking tier cover. Accordingly, the cooking tier covers may fill a gap between the cooking tiers 30a, 30b, and 30c when in a stacked configuration. In one embodiment, as illustrated in FIG. 6B, the dimensions of the cooking tier covers 34a, 34b may be 13″×13″×1″ in length, width, and height respectively. In another embodiment, the cooking tier cover may be hollow such that it serves as additional storage space or a bucket when extended outwardly from the respective cooking tier.

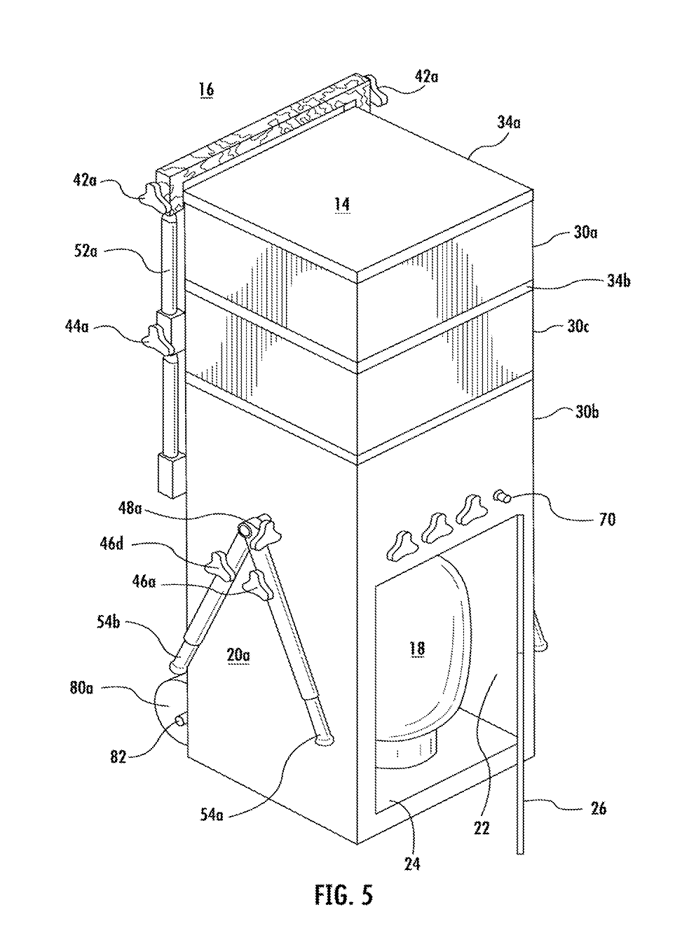

As illustrated in FIG. 5, the cooking tiers 30a, 30b, 30c may be arranged in a stack, such that the cooking tiers 30a, 30b, 30c extend across a third axis C, in an adjacent manner. As illustrated, in an embodiment comprising three cooking tiers 30a, 30b, 30c, any of the three cooking tiers may be placed in any of a first, second, or third position in the stack, from top to bottom respectively. In one embodiment, the exterior cooking tier 30a may be elevated, along a third axis C, above central cooking tier 30b, and pivoted 90°, in the positive direction of axis A, such that, when in the stacked position, the cooking tier 30a may rest on top of the cooking surface 32b. This is a second position of the stack, and the cooking tier 30a may be aligned with central cooking tier 30b, where cooking tier 30b may be in a third position of the stack. The exterior cooking tier 30c may be elevated, along a third axis C, above cooking tiers 30a, 30b, and pivoted 90°, in the negative direction of a first axis A, such that when in resting position, the cooking tier 30c may rest on top of the cooking surface 32a, in a first position of the stack, and may be aligned with exterior cooking tier 30a, where cooking tier 30a may be in a second position of the stack. In another embodiment, the exterior cooking tier 30c may be elevated, along a third axis C, above central cooking tier 30b, and pivoted 90°, in the negative direction of a first axis A, such that when in resting position, the cooking tier 30c may rest on top of the cooking surface 32b. This is a second position of the stack, and the cooking tier 30b may be aligned with central cooking tier 30b, where cooking tier 30b may be in a third position of the stack. The exterior cooking tier 30a may be elevated, along a third axis C, above cooking tiers 30b, 30c, and pivoted 90°, in the positive direction of axis A, such that when in resting position, the cooking tier 30a may rest on top of the cooking surface 32c. This is a first position of the stack, and the cooking tier 30a may be aligned with exterior cooking tier 30c, where cooking tier 30c may be in a second position of the stack. As such, the cooking tiers 30a, 30b, 30c may be directly aligned with one another, along a third axis C when in a stacked configuration. It should be noted that in an embodiment where the central cooking tier is non-stationary the cooking tiers 30a, 30b, 30c may be arranged in any configuration, such that each cooking tier may be in either the first, second, or third position of the stack. For example, in one embodiment, cooking tier 30b may be in the first position of the stack, cooking tier 30a may be in the second position of the stack, and cooking tier 30c may be in the third position of the stack.

As illustrated, the one or more cooking tiers 30a, 30b, 30c comprise cooking surfaces 32a, 32b, 32c respectively, controlled by cooking tier control panel 70. The one or more cooking surfaces 32a, 32b; 32c may comprise a plurality of means for cooking. Means for cooking may include, but not be limited to coil burners, flat top burners, infrared grill burners, gas grills, charcoal grills, hibachi grills, kettle grills, ceramic cookers, food warmers and the like. The grills may comprise a cooking grate. In one embodiment, the cooking surfaces 32a, 32b, 32c may be a combination of any three means for cooking. In one embodiment, the cooking surfaces 32a, 32b, 32c may be connected, via a propane regulator, to a propane tank located in the containment space 18. The propane regulator may be connected to one or more cooking surfaces. In one embodiment, the propane regulator may be externally connected to the respective cooking surface. For example, the propane regulator may be located on containment wall 20c along the backside of containment space 18. The propane regular may be eight (8) inches in length such that it may extend from the propane tank and may be connected to the left side of a cooking surface, where the cooking surface may be a burner. In another embodiment, the propane regulator may be connected internally to the respective cooking surface. In one embodiment, the propane regulator may be disconnected from one or more cooking surfaces 32a, 32b, 32c when the cooking arrangement 30 is in a stacked configuration. In another embodiment, the propane regulator may be permanently attached to one or more cooking surfaces 32a, 32b, 32c. In one embodiment, the cooking surface may comprise a removable cooking grate and the cooking tier may be hollow such that when the cooking grate is removed the cooking tier may be filled with coal or fuel. In an alternative embodiment, the cooking surface may comprise a non-removable cooking grate and the cooking tier may comprise a cooking tier door, such that when the cooking tier door is opened the hollow portion of the cooking tier may be filled with coal or fuel. In one embodiment, the cooking surfaces 32a, 32b, 32c are individually adjustable and may be positioned at different heights. For example, in an embodiment where the cooking surface is a burner, the burner may be adjusted to a lower height such that that burner is lower into the respective cooking tier. In another embodiment where the cooking surface is a burner, the burner may be adjusted higher such that that burner is significantly raised above the respective cooking tier. The cooking tiers may be controlled by one or more controls located on cooking tier control panel 70. The one or more controls may include, but not be limited to, burner controls, spark igniters, temperature controls, refrigeration controls, and the like. In one embodiment, as illustrated in FIG. 6B, the dimensions of the cooking tier control panel 70 may be 13″×13″×2.5″ in length, width, and height respectively.

As illustrated in FIG. 1, the structural frame 16 is defined by a handle 52, a pair of support arms 54a, 54b, a first pair of telescoping legs 56a, 56b, and a second pair of telescoping legs 58a, 58b, a pair of wheels 80a, 80b, and a wheel axle 82. The support arms 54a, 54b extend vertically along a third axis C. In one embodiment, the length of the support arms 54a, 54b may be increased or decreased using adjustable dials 42a, 42b, 48a, 48b. In one embodiment, the cooking tiers 30a, 30b may be connected to support arms 54a, 54b respectively, using adjustable dials 44a, and 44b respectively. Adjustable dials 44a; 44b may be loosened such that cooking tiers 30a, 30b may be elevated about support arms 54a, 54b, along a third axis C. Additionally, adjustable dials 44a, 44b may be loosened such that cooking tiers 30a, 30b may be pivoted about support arms 54a, 54b, along a third axis C, in either the positive or negative direction of a second axis B. As such, adjustable dials 44a, 44b may be tightened to secure the position of cooking tiers 30a, 30b when they have been arranged in a desired position. In one embodiment, support arms 54a, 54b may comprise one or more wheels to aid in the mobility of the portable cooking device 10.

The first and second pair of telescoping legs 54a, 54b, 56a, 56b may be shaped in an A frame. As illustrated, the first pair of telescoping legs 54a, 54b may be connected to containment wall 20a, such that the first pair of telescoping legs 54a, 54b may be extended to ground level and provide additional stability for the portable cooking device 10. The second pair of telescoping legs 56a, 56b may be connected to containment wall 20b, such that the second pair of telescoping legs 56a, 56b may be extended to ground level and provide additional stability for the portable cooking device 10. The length of the telescoping legs 54a, 54b, 56a, and 56b may be adjusted using adjustable dial 46a, 46d, 46b, and 46c respectively. Adjustable dials 46a, 46b, 46c, 46d may be loosened such that the telescoping legs 54a, 54b, 56a, 56b may be extended or contracted to either increase or decrease the length of the telescoping legs 54a, 54b, 56a, 56b. As such, adjustable dials 46a, 46b, 46c, 46d may be tightened to secure the position of telescoping legs 54a, 54b, 56a, and 56b when they have been arranged a desired position.

As illustrated, the pair of wheels 80a, 80b may be located on wheel axle 82 in the rear of the portable cooking device 10. In one embodiment, the wheel axle may located at the bottom of the structural frame 16, such that when the portable cooking device 10 is in an upright position the pair of wheels 80a, 80b do not touch the ground. In another embodiment, where the portable cooking device 10 is tilted towards the rear of the device, the portable cooking device 10 may be rolled using wheels 80a, 80b. The portable cooking device 10 may be tilted and moved using the handle 52 and the pair of wheels 80a, 80b.

Certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A portable cooking device comprising:
a structural frame; and
a cooking tier arrangement comprising:
a first cooking tier comprising a first cooking surface and a first heating component, the first cooking tier connected to the structural frame; and
a second cooking tier comprising a second cooking surface and a second heating component, the second cooking tier connected to the structural frame;
wherein the first cooking tier or the second cooking tier is adjustable with respect to the structural frame such that the cooking tiers may be re-arranged from a cooking configuration to a a stack configuration wherein one of the cooking tiers is positioned substantially above the cooking surface of the other cooking tier.

2. The portable cooking device of claim 1, wherein the first cooking surface and the second cooking surface are substantially parallel when in the cooking configuration.

3. The portable cooking device of claim 1, wherein the first cooking tier defines a containment space configured to hold a fuel tank functionally connected with the first heating component or the second heating component by a propane regulator and for fueling the functionally connected heating component.

4. The portable cooking device of claim 1, wherein the first cooking tier or the second cooking tier comprises a cooking tier cover for covering the cooking surface when the heating component is not in use.

5. The portable cooking device of claim 4, wherein the cooking tier cover is configured to extend from the cooking surface of the cooking tier when not covering the heating component for use as a table.

6. The portable cooking device of claim 1, wherein the first cooking tier or the second cooking tier comprises a cooking tier hood for providing a grilling hood when the heating component is in use.

7. The portable cooking device of claim 4, wherein the cooking tier cover is detachable and re-attachable for covering the other cooking surface.

8. The portable cooking device of claim 1, further comprising:
a cooking tier control panel comprising at least one heating component controls for controlling the first or second heating components.

9. The portable cooking device of claim 1, wherein the structural frame comprises:
a first and second cooking tier support arms connected to the first or second cooking tier; and
a first and second pair of telescoping legs attached to the first and second cooking tier support arms, respectively.

10. The portable cooking device of claim 1, wherein the structural frame comprises:
a wheel axel;
a pair of wheels attached to the wheel axel and for rotating about the wheel axel; and
a handle configured for assisting a user to move the portable cooking device by holding the handle and rolling the wheels.

11. A portable cooking device comprising:
a structural frame; and
a cooking tier arrangement comprising:
a central cooking tier comprising a central cooking surface and a central heating component, the central cooking tier connected to the structural frame;
a first exterior cooking tier comprising a first exterior cooking surface and a first exterior heating component, the first exterior cooking tier connected to the structural frame; and
a second exterior cooking tier comprising a second exterior cooking surface and a second exterior heating component, the second exterior cooking tier connected to the structural frame;
wherein the first exterior cooking tier and the second exterior cooking tiers are adjustable with respect to the structural frame such that the cooking tiers may be arranged in a stack configuration whereby the first exterior cooking tier and the second exterior cooking tier are positioned substantially above the central cooking surface of the central cooking tier.

12. The portable cooking device of claim 11,
wherein in the stack configuration, the second exterior cooking tier is positioned substantially above the first exterior cooking surface of the first exterior cooking tier.

13. A portable cooking device comprising:
a structural frame comprising a first pair of telescoping legs configured to extend to the ground for stabilizing the portable cooking device; and
a cooking tier arrangement comprising:
a first cooking tier comprising a first cooking surface and a first heating component, the first cooking tier connected to the structural frame; and
a second cooking tier comprising a second cooking surface and a second heating component, the second cooking tier connected to the structural frame;
wherein the first cooking tier or the second cooking tier is adjustable with respect to the structural frame such that the cooking tiers may be arranged in a stack configuration whereby one of the cooking tiers is positioned substantially above the cooking surface of the other cooking tier.

14. The portable cooking device of claim 13, wherein the structural frame further comprises a second pair of telescoping legs configured to extend to the ground for further stabilizing the portable cooking device.

15. The portable cooking device of claim 13, wherein the cooking tier arrangement further comprises:
a third cooking tier comprising a third cooking surface and a third heating component, the third cooking tier connected to the structural frame; and
wherein the first cooking tier is a central cooking tier and the second and third cooking tiers are exterior cooking tiers.

16. The portable cooking device of claim 14, wherein the first pair of legs and the second pair of legs are functionally connected to the first cooking tier and are disposed on opposite sides of the first cooking tier.

17. The portable cooking device of claim 15,
wherein the first cooking tier defines a containment space configured to hold a fuel tank functionally connected with the first heating component or the second heating component by a propane regulator and for fueling the functionally connected heating component.

18. The portable cooking device of claim 15, wherein the first cooking tier or the second cooking tier comprises a cooking tier cover for covering the cooking surface when the heating component is not in use.

19. The portable cooking device of claim 18, wherein the cooking tier cover is configured to extend from the cooking surface of the cooking tier when not covering the heating component for use as a table

20. The portable cooking device of claim 15, wherein the structural frame comprises:
a wheel axel;
a pair of wheels attached to the wheel axel and for rotating about the wheel axel; and
a handle configured for assisting a user to move the portable cooking device by holding the handle and rolling the wheels.
